(19) United States
(12) Patent Application Publication
(10) Pub. No.: US 2009/0260594 A1
(43) Pub. Date: Oct. 22, 2009

(54) IN-CYLINDER FUEL-INJECTION TYPE INTERNAL COMBUSTION ENGINE, PISTON FOR IN-CYLINDER FUEL-INJECTION TYPE INTERNAL COMBUSTION ENGINE AND PROCESS FOR MANUFACTURING PISTON FOR IN-CYLINDER FUEL-INJECTION TYPE INTERNAL COMBUSTION ENGINE

(76) Inventors: Masashi HARA, Nagoya-shi (JP); Kazuhiko Itoh, Seto-shi (JP); Mikio Kondoh, Toyoake-shi (JP); Kazuaki Nishino, Seto-shi (JP); Isamu Ueda, Kasugai-shi (JP); Kimihiko Ando, Toyota-shi (JP); Yoshihiko Ito, Nagoya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/424,808

(22) Filed: Apr. 16, 2009

(30) Foreign Application Priority Data
Apr. 16, 2008 (JP) 2008-106944(PAT)

(51) Int. Cl. F02F 3/00; B23P 15/10

(52) U.S. Cl. 123/193.6; 29/888.04

(57) ABSTRACT

A piston for in-cylinder fuel-injection type internal combustion engine includes a piston body, a low thermal conductor, and a piston head. The low thermal conductor is disposed on the top of the piston body. The low thermal conductor includes a low thermally-conductive substrate, and a coating layer. The low thermally-conductive substrate has opposite surfaces. The coating layer includes alumina fine particles (Al₂O₃). The coating layer is adhered on at least a part one of the opposite surfaces of the low thermally-conductive substrate that makes a cast-buried or enveloped surface to be cast buried or enveloped in the piston head.

### INCORPORATION BY REFERENCE

The present invention is based on Japanese Patent Application No. 2008-106,944, filed on Apr. 16, 2008, the entire contents of which are incorporated herein by reference.

### BACKGROUND OF THE INVENTION

1. Field of the Invention

The present invention relates to an in-cylinder fuel-injection type internal combustion engine, such as diesel engines and gasoline engines, a piston for in-cylinder fuel-injection type internal combustion engine, piston which is provided with a low thermal conductor for facilitating the atomization or vaporization of liquid fuel that is injected into the internal combustion engine's cylinder, and a process for manufacturing the piston.

2. Description of the Related Art

As environmental consciousness has been growing, it has been required strongly to make internal combustion engines, such as diesel engines and gasoline engines that are used for automobiles, motorcycles and industrial machines, consume fuels less, and to make the exhaust gases being emitted from them clean. For example, from the viewpoint of saving fuel consumption, in-cylinder fuel-injection type gasoline engines have come to be adopted even in ordinary commercially-available cars recently.

However, in in-cylinder fuel-injection type internal combustion engine, it is not easy to always atomize or vaporize the fuel fully, because the injection amount and injection timing of fuel that is injected into the cylinders fluctuate depending on loads to the internal combustion engine. Accordingly, an adverse effect, such as the incomplete combustion of fuel, has arisen, albeit only slightly, so that the fuel consumption might have degraded or the emissions of hydrocarbons and soot might have increased in the exhaust gases, though even temporarily, when cold running the internal combustion engine. Although recent automobiles have certainly been equipped with exhaust-gas purifying catalytic apparatuses, the catalysts are not activated unless their temperatures are raised to a certain extent. Consequently, it has been likely that such an instance that the exhaust gases are purified insufficiently might occur when cold running the internal combustion engines, that is, immediately after starting them up, for instance.

In particular, in-cylinder fuel-injection type gasoline engine carries out the stratified charge combustion in super fuel-lean atmosphere with high air-fuel ratio in addition to carrying out uniformly-mixed combustion. Accordingly, if the fuel is atomized or vaporized insufficiently around the spark plugs when the internal combustion engine carries out the stratified charge combustion, unburned gases might be discharged, for instance, as the ignitability of fuel degrades. Consequently, it might be even possible for such insufficient atomization or vaporization to adversely affect making the internal combustion engine consume fuel less and making the exhaust gases clean.

Under such circumstances, in order to facilitate the atomization or vaporization of injected fuel, it has been proposed heretofore, for instance, to provide the top surface of piston with a low thermally-conductive zone, which can become a higher temperature than that of the surroundings, within the fuel collision zone. For example, Japanese Unexamined Patent Publication (KOKAI) Gazette No. 2000-186,617 (i.e., Japanese Patent Gazette No. 3,551,801) discloses such a technique specifically.

Japanese Patent Gazette No. 3,551,801 proposes to place a plate that comprises a low thermally-conductive material (that is, a low thermal conductor) on the fuel collision part in the top surface of a piston for in-cylinder fuel-injection type spark-ignition engine in order to facilitate the evaporation of fuel and in order to decrease the adhesion of fuel. Besides placing the plate, Japanese Patent Gazette No. 3,551,801 also proposes to form a highly heat-insultative minute-intersticed layer between the plate and the piston body by turning the rear surface of the plate into an irregular shape.

However, according to surveys and studies that the present inventors have carried out so far, it has been found difficult to actually form such a minute-intersticed layer as disclosed in Japanese Patent Gazette No. 3,551,801 when the plate whose rear surface is turned into an irregular shape is simply cast buried or enveloped in the piston with an aluminum-alloy molten metal. That is, the formation of the minute-intersticed layer is hardly possible because the molten metal flows unstably during the cast burying or enveloping. Moreover, turning the rear surface of the plate as an irregular shape is likely to result in increased manufacturing costs. In addition, considering the large explosive forces that act onto the piston, it is impossible to thin out the plate on the rear-surface side or reduce the plate's thickness from the viewpoint of the strength and rigidity.

The present invention has been developed in view of such circumstances. Specifically, it is an object of the present invention to provide a piston for in-cylinder fuel-injection type internal combustion engine, piston which enables a low thermal conductor that is cast buried or enveloped in the piston's top to exhibit furthermore enhanced heat insulating property more securely and actively. Moreover, it is another object of the present invention to provide an in-cylinder fuel-injection type internal combustion engine using the piston. In addition, it is still another object of the present invention to provide a process for manufacturing the piston for in-cylinder fuel-injection type internal combustion engine.

### SUMMARY OF THE INVENTION

The present inventors studied earnestly to solve the aforementioned problems. As a result of their repeated trial and error, they arrived at thinking of disposing a coating layer, which comprises alumina fine particles (Al₂O₃), on the rear surface of a low thermally-conductive substrate that is cast buried or enveloped in the top of piston. Moreover, they newly found out that, when cast burying or enveloping the low thermally-conductive substrate with the coating layer being provided in the top of piston using an aluminum-alloy molten metal, it is possible to form a minute-intersticed layer in which the alumina fine particles intervene between a cast-buried or enveloped surface, namely, the rear surface of the substrate, and the body of the resulting piston. Thus, based on such an achievement, they arrived at completing the present invention as described below.

### Piston for In-Cylinder Fuel-Injection Type Internal Combustion Engine

For example, a piston for in-cylinder fuel-injection type internal combustion engine according to the present invention comprises:
a piston body having a top, and being disposed reciprocably within a cylinder in a cylinder block of the internal combustion engine;
a low thermal conductor for forming a low thermally-conductive zone whose thermal conductivity is lower than that of the surroundings, and the low thermal conductor making at least a part of a fuel collision zone with which liquid fuel is collidable, the liquid fuel being injected from a fuel injection valve into the cylinder, the fuel injection valve being disposed in a cylinder head that is disposed on the cylinder block; and
a piston head in which the low thermal conductor being disposed on the top of the piston body is cast buried;
the piston head comprising an aluminum-alloy casting; and
the low thermal conductor comprising a low thermally-conductive substrate having opposite surfaces, and a coating layer being adhered on at least a part of one of the opposite surfaces of the low thermally-conductive substrate that makes a cast-buried surface to be cast buried in the top of the piston body, and the coating layer comprising alumina (Al₂O₃) fine particles.

The piston for in-cylinder fuel-injection type internal combustion engine according to the present invention makes it possible to reliably form the low thermal-conductive zone, which exhibits very low thermally-conducting property, in the fuel collision zone. Consequently, the present piston enables liquid fuels, which are injected in the cylinder of the internal combustion engine, to atomize or vaporize more reliably. Thus, an in-cylinder fuel-injection type internal combustion engine using the present piston makes it possible to upgrade the fuel consumption and purify the exhaust gases more reliably than conventional ones do.

Meanwhile, it has not necessarily been cleared yet in detail how the piston for in-cylinder fuel-injection type combustion engine according to present invention operates to produce the outstanding advantages as described above. However, it is believed tentatively to be as hereinafter described.

First off, the alumina fine particles are so-called ceramic fine particles, and they themselves exhibit lower thermal conductivity than aluminum alloys and iron alloys do. Accordingly, the coating layer itself that comprises the alumina fine particles turns into a so-called heat insulating layer. Consequently, the coating layer inhibits heat from transferring between the low thermal conductor proper and the piston body, namely, the cast-product part that is made of aluminum alloy. Therefore, the low thermal conductor becomes likely to undergo temperature rise.

Moreover, in the piston for in-cylinder fuel-injection type combustion engine according to the present invention, the presence of the coating layer makes it easy to form a minute-intersticed layer between the low thermal conductor per se and the piston body in addition to the coating layer's own low thermally-conducting property. Although it is difficult to identify the form of the minute interstices, it does not matter whether the minute interstices can be either continuous minute interstices in the coating layer or scattering minute independent pores that exist between the alumina fine particles therein, for instance. In any case, the minute-intersticed layer demonstrates good heat insulating property because it exhibits remarkably lower thermal conductivity than that of the low thermally-conductive substrate proper.

Therefore, it eventually becomes possible to obstruct the heat transfer from the low thermal conductor to the piston body more greatly and reliably than having been done conventionally, because the heat insulating property resulting from the minute-intersticed layer are added to the heat insulating property of the low thermally-conductive substrate itself and the heat insulating property of the coating layer itself. As a result, the low thermal conductor with which liquid fuels collide can facilitate the atomization or vaporization of the liquid fuels, because the low thermal conductor is likely to become higher temperatures than that of the surroundings far better than conventional ones do, and more reliably as well. All in all, the low thermal conductor makes it possible to upgrade the fuel consumption of in-cylinder fuel-injection type internal combustion engine and the performance for purifying the exhaust gases emitted from the same.

In addition to the above, the piston for in-cylinder fuel-injection type combustion engine according to the present invention comprises the low thermal conductor that can be made virtually by simply providing one of the opposite surfaces to be cast buried or enveloped with the coating layer. Accordingly, the present piston does not require such processes at all that result in increasing the manufacturing costs. Consequently, the present piston enables manufacturers to intend reducing the manufacturing costs.

Note herein that it has not necessarily been possible yet to detail what a mechanism works to form the minute-intersticed layer at around the boundary surface between the low thermal conductor and the piston body when the low thermal conductor with the coating layer being provided is cast buried or enveloped in the piston body. However, it is believed to be as described below at present. That is, the coating layer that comprises the alumina fine particles is less likely to be wetted with an aluminum-alloy molten metal. Because of the coating layer's this low wettability, the aluminum-alloy molten metal has been repelled at sections where it comes in contact with the coating layer. Accordingly, the minute interstices between the alumina fine particles are hardly impregnated with the aluminum-alloy molten metal. Consequently, it seems that the low thermal conductor and the piston body are not joined to each other so that the minute interstices come to be formed at the boundary-surface sections between them.

Moreover, it appears at first glance that such minute interstices or the minute-intersticed layer might become the cause of the deformation or flexure of the low thermal conductor onto which the great explosive forces act. However, the deformation or flexure of the low thermal conductor, which might result from the minute interstices or minute-intersticed layer, does not matter, because the minute interstices or minute-intersticed layer that is formed actually is an assemblage of fine pores whose pore diameters are from 5 to 50 μm approximately, or because the resulting minute interstices or minute-intersticed layer comprises only voids whose thicknesses are no larger than 0.5 mm approximately. Besides that, the resultant minute interstices or minute-intersticed layer does not make absolutely perfect minute interstices. That is, the alumina fine particles that constitute the coating layer are present in such a state that they intervene between the low thermal conductor and the piston body. This can be approximated to such a state that a large number of the alumina fine particles turn into so-called “pillars” to support the minute interstices. In addition to that, the alumina fine particles are ceramic particles with high strength. Therefore, it is believed that the deformation or flexure of the low thermal conductor, which might result from the minute interstices or minute-intersticed layer, does not matter even when the low thermal conductor is subjected to the great explosive forces repeatedly.

### Process for Manufacturing Piston for In-Cylinder Fuel-Injection Type Internal Combustion Engine

It is possible to grasp the present invention as a process for manufacturing the above-described piston for in-cylinder fuel-injection type internal combustion engine as well. For example, it is allowable to comprehend the present invention as a process for manufacturing piston for in-cylinder fuel-injection type internal combustion engine, the piston comprising: a piston body having a top, and being disposed reciprocably within a cylinder in a cylinder block of the internal combustion engine; a low thermal conductor for forming a low thermally-conductive zone whose thermal conductivity is lower than that of the surroundings, and the low thermal conductor making at least a part of a fuel collision zone with which liquid fuel is collidable, the liquid fuel being injected from a fuel injection valve into the cylinder, the fuel injection valve being disposed in a cylinder head that is disposed on the cylinder block; and a piston head in which the low thermal conductor being disposed on the top of the piston body is cast buried;
the manufacturing process comprises the steps of:
adhering a coating material comprising alumina fine particles onto at least a part of one of opposite surfaces of a low thermally-conductive substrate, thereby forming a coating layer on one of the opposite surfaces; and
casting the piston head while contacting the one of the opposite surfaces of the low thermally-conductive substrate that is provided with the coating layer with a molten metal of aluminum alloy, thereby making an aluminum-alloy piston head in which the low thermal conductor is cast buried.

### In-Cylinder Fuel-Injection Type Internal Combustion Engine

Moreover, it is possible to grasp the present invention not only as the present piston per se for in-cylinder fuel-injection type internal combustion engine but also as an in-cylinder fuel-injection type internal combustion chamber proper using the same. For example, it is allowable to comprehend the present invention as an in-cylinder fuel-injection type internal combustion engine, which comprises:
a cylinder block having a cylinder;
a cylinder head being disposed on the cylinder block;
a fuel injection valve being disposed in the cylinder head; and
the above-described piston for in-cylinder fuel-injection type internal combustion engine according to the present invention.

### Optional Constructions

In addition to the above-described fundamental constructions, it is proper that the present invention can further comprise any one optional feature that is selected from the following optional constructions given below, or any two or more of optional features that are selected therefrom. It should be noted however that it is feasible to apply the optional constructions that are selected from those described below at discretion and in superposed or composite manners to the piston, in-cylinder fuel-injection type internal combustion engine and manufacturing process according to the present invention.

Moreover, the piston, in-cylinder fuel-injection type combustion engine using the same, and process for manufacturing the same according to the present invention will be hereinafter described separately or distinctively for convenience. However, it is feasible to appropriately combine any two or more of the following optional constructions with each other at will beyond the categories. That is, it is needless to say that the optional construction that is directed to a coating material for the low thermal conductor, for instance, can be relevant not only to the present piston per se for in-cylinder fuel-injection type internal combustion engine, but also to the present process for manufacturing the same. In addition, although it simply appears that an optional construction is directed to a “process,” the optional construction can turn into an optional construction that is directed to a “product” when comprehending it as a claim being written, in the form of “product-by-process.”

### (I) Optional Constructions Relevant to Piston for In-Cylinder Fuel-Injection Type Internal Combustion Engine

The following are optional constructions for the piston according to the present invention:
(I)-(i) The low thermally-conductive substrate can preferably comprise: manganese (Mn) in an amount of from 5 to 35% by mass; carbon (C) in an amount of from 0.5 to 1.5% by mass, and the balance of iron (Fe) and inevitable impurities or modifying elements; when the entirety is taken as 100% by mass. For example, the modifying elements can preferably be Si, P, S, O, N, Cu, Ni, Cr, Mo, Nb, V, and Ti Moreover, the Mn content can more preferably be from 7 to 30% by mass; and the C content can more preferably be from 0.8 to 1.2% mass;
(I)-(ii) The low thermally-conductive substrate can preferably have the cast-buried or cast-enveloped surface that is formed as an irregular shape partially at least;
(I)-(iii) The alumina fine particles can preferably exhibit an average particle diameter of from 5 to 50 μm. Moreover, the average particle diameter can mere preferably be from 10 to 40 μm;
(I)-(iv) The coating layer can preferably have a thickness of from 0.01 to 0.30 mm. Moreover, the thickness can more preferably be from 0.10 to 0.20 mm;
(I)-(v) The alumina fine particles can preferably be present in the coating layer in a proportion of from 5 to 100% by volume when the entire coating layer is taken as 100% by volume. Moreover, the presence proportion can more preferably be from 20 to 80% by volume; and
(T)-(vi) The low thermally-conductive substrate can preferably comprise a Ti alloy or a stainless alloy (or Fe—Cr alloy).

### (II) Optional Constructions Relevant to Process for Manufacturing Piston for In-Cylinder Fuel-Injection Type Internal Combustion Engine

Optional constructions for the process for manufacturing piston for in-cylinder fuel-injection type internal combustion engine according to the present invention are as follows:
(II)-(i) The adhering step can preferably comprise a step of immersing at least a part of one of the opposite surfaces of the low thermally-conductive substrate into a coating solution or dispersion liquid in which the coating material is dispersed in a solvent or dispersant;
(II)-(ii) The adhering step can preferably comprise a step of applying a coating solution or dispersion liquid in which the coating material is dispersed in a solvent or dispersant onto at least a part of one of the opposite surfaces of the low thermally-conductive substrate;
(II)-(iii) The adhering step can preferably further comprise a step of drying the low thermally-conductive substrate, which has been immersed into the coating solution or dispersion liquid, or on which the coating solution or dispersion liquid has been applied;
(II)-(iv) The solvent or dispersant can preferably comprise water or alcohol;
(II) -(v) In preparing the coating solution or dispersion liquid, the coating material can preferably be mixed with the solvent or dispersant in a proportion of from 1 to 2 by mass with respect to a mass of the solvent or dispersant;
(II)-(vi) The coating material can preferably comprise at least one member that is selected from the group consisting of alumina powders and alumina-containing clays;
(II)-(vii) The coating material can preferably comprise a mixture of an alumina powder and an alumina-containing clay;
(III)-(viii) In preparing the mixture, the alumina-containing clay can preferably be mixed with the alumina powder in a proportion of from 0 to 80 by mass with respect to a mass of the alumina powder;
(II)-(ix) The alumina-containing clays can preferably comprise an alumina-silica hydrate; and
(II)-(x) The low thermally-conductive substrate can preferably be dried at a temperature of 50° C. or more in the drying step.

### (III) Optional Constructions Relevant to In-Cylinder Fuel-Injection Type Internal Combustion Engine

The in-cylinder fuel-injection type internal combustion engine according to the present invention can naturally make not only gasoline engines but also diesel engine.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a partial cross-sectional diagram for illustrating an in-cylinder fuel-injection type internal combustion engine according to an example of the present invention.

FIG. 2 is a photograph for showing a vertical cross-sectional view of a test specimen in which a low thermal conductor that, is directed to a piston according to another example of the present invention is cast buried or enveloped.

FIG. 3 is a photograph for showing a vertical cross-sectional view of a comparative test specimen in which another low thermal conductor that is not provided with any coating layer is cast buried or enveloped.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

The present invention will be described in more detail while naming specific embodiment modes. It should be noted that, including the following embodiment modes, disclosures being described in the present specification are appropriately applicable not only to an in-cylinder fuel-injection type internal combustion engine according to the present invention and a piston for the same but also to a process for manufacturing the piston. Moreover, it should be also noted that which of the following embodiment modes is considered best depends on objects to which they are applied and on the objects' performance requirements.

### (A) Low Thermally-Conductive Substrate

It is allowable that a low thermally-conductive substrate that is directed to the present invention can comprise stainless-alloy system materials and Ti-alloy system materials, in addition to Fe—Mn—C-alloy system materials. The low thermally-conductive substrate can preferably comprise a material whose thermal conductivity is lower than that of an aluminum alloy making a piston according to the present invention. However, in the low thermally-conductive substrate, it does not necessarily matter to what extent the low thermal-conductive substrate exhibits low thermal conductivity specifically, because a later-described coating layer produces great heat-insulating effect.

Since the low thermally-conductive substrate is cast buried or enveloped in a piston according to the present, invention which reciprocates at high speeds and at the same to which the large explosive forces act, the low thermally-conductive substrate does not disturb the piston's functions. Concretely speaking, it is necessary that the low thermally-conductive substrate can be provided with required mechanical strength and rigidity, and at the same time with such thermal fatigue strength that it can withstand repeated cooling/heating cycles, for instance. In particular, from the viewpoint of the latter, the low thermally-conductive substrate can preferably exhibit a coefficient of linear expansion that can be approximated to the coefficient of linear expansion of aluminum alloy, a major material for making a piston according to the present invention. Moreover, the low thermally-conductive substrate can preferably exhibit such castability (or cast-burying or enveloping ability) that it exerts good adhesiveness to the aluminum alloy, excepting a surface to which a later-described coating layer adheres.

When the low thermally-conductive substrate comprises an Fe—Mn—C-alloy system material, it can include one or more modifying elements in a small amount, in addition to Mn, C and Fe and inevitable impurities that make the balance. The “modifying elements” are elements that the low thermally-conductive substrate is allowed to contain auxiliarily or secondarily as far as they do not impair the characteristics of the low thermally-conductive substrate fundamentally. It does not matter whether the modifying elements improve the characteristic of the low thermally-conductive substrate or not. Even if they do not produce such an effect of improving the characteristics, they are included in the category of modifying elements as far as they are elements that do not impair the fundamental characteristics of the low thermally-conductive substrate. Moreover, the “inevitable impurities” include impurities that are contained in raw materials, and impurities that get mixed in during the production, that is, they are elements that are difficult to remove for cost or technical reasons.

For example, an Fe—Mn—C alloy that the present inventors have been developing separately will be hereinafter described supplementarily.

Firstly, when the Fe—Mn—C alloy comprises Mn in an amount of from 5 to 35% by mass with respect to the entirely taken as 100% by mass, the resulting low thermally-conductive substrate can exhibit desirable thermal conductivity and linear-expansion coefficient stably. On the other hand, when it comprises Mn too less, it is not preferable because the resultant low thermally-conductive substrate has exhibited sharply increasing thermal conductivity. Moreover, when it comprises Mn too much, the resulting, low thermally-conductive substrate does not exhibit a desirable linear-expansion coefficient because the linear-expansion coefficient has declined. A preferable Mn content of the Fe—Mn—C alloy can be from 7 to 30% by mass with respect to the entirely taken as 100% by mass.

Secondly, it is possible for the Fe—Mn—C alloy, which comprises C in an amount of from 0.5 to 1.5% by mass with respect to the entirely taken as 100% by mass, to produce the low thermally-conductive substrate that exhibits desirable thermal conductivity and linear-expansion coefficient stably. On the contrary, the Fe—Mn—C alloy, which comprises C too less, is not preferable because it has resulted in making the low thermally-conductive substrate that exhibits thermal conductivity which increases sharply and linear-expansion coefficient which is lower than the lower limit of the desirable range. On the other hand, the Fe—Mn—C alloy, which comprises an increased amount of C, is preferable because it can produce the low thermally-conductive substrate whose thermal conductivity and linear-expansion coefficient approach so as to fall in their desirable ranges. However, the Fe—Mn—C alloy, which comprises C too much, is not preferable because it has resulted in making the low thermally-conductive substrate with sharply decreasing tensile strength to such an extent that it might serve no practical use. The Fe—Mn—C alloy can preferably comprise C in an amount of from 0.8 to 1.2% by mass with respect to the entirety taken as 100% by mass.

Thirdly, Fe is the major component that makes the Fe—Mn—C alloy. However, when Mn and C are added to Fe in the aforementioned specific amounts, the resulting Fe—Mn—C alloy comes to exhibit characteristics that are much distinct from those of usual iron system materials. Observing the Fe—Mn—C alloy from the viewpoint of thermal conductivity and linear-expansion coefficient at least, the Fe—Mn—C alloy demonstrates the above-described good characteristics so that it cannot be considered an iron-based alloy.

Fourthly, the basic constituent elements of the Fe—Mn—C alloy are the three elements, namely, Mn, C and Fe. However, in addition to Mn, C and Fe, the Fe—Mn—C alloy can further comprise a modifying element. As the modifying element, it is possible to name Si, P, S, 0, N, Cu, Ni, Cr, Mo, Nb, V and Ti, for instance. The content of such a modifying element can usually be a trace amount of from 0.01 to 1% by mass with respect to the entirety taken as 100% by mass.

Note that the numeric ranges, such as “from ‘x’ to ‘y’” as set forth in the present specification, include the lower limit value, “x,” and the upper limit value, “y,” unless otherwise specified. Moreover, it should be noted that, in addition to the numeric values that are specified as the upper limit values and lower limit values as described in the present specification, it is possible to optionally combine any of the following numeric values, such as those being recited in the section of “EXAMPLE,” to establish new upper and lower limit values or new numeric ranges like “from ‘a’ to ‘b’.”

Finally, the Fe—Mn—C alloy exhibits thermal conductivity that is smaller than that of aluminum alloy, a material for making piston, by a factor of from 1/10 to 1/20, for example, from 7 to 13 W/m·K. On the other hand, the coefficient of linear expansion of the Fe—Mn—C alloy is about 20×10⁻⁶/K (for example, from 15 to 25×10⁻⁶/K), and can be approximated to that of the piston body virtually. Therefore, even when the low thermal conductor whose composition differs from that of the fuel collision zone in the piton's top, it is less likely to cause the inconveniences, such as the coming off or breakdown between the low thermal conductor and the piston head, and the thermal-fatigue breakdown that results from being subjected to repetitive thermal stresses.

Moreover, it is possible to modify only the superficial layer of the low thermally-conductive alloy that is directed to the present invention, namely, the outermost layer of the low-thermally conductive substrate alone, if necessary, by carrying out a known carburizing treatment or nitriding treatment, independently of a later-described coating treatment that is directed to the present invention. The purpose of this additional treatment is not limited to improving the low thermally-conductive alloy's strength. That is, it is feasible to utilize the additional treatment for the undercoating treatment for diamond-like-carbon (or DLC) film, for instance. In addition, when the low thermally-conductive substrate comprises a sintered body, it is allowable to subject one of the surfaces of the low thermally-conductive substrate to a pore-closing treatment. The pore-closing treatment inhibits the inside of the low thermally-conductive substrate from being impregnated with liquid fuel, and thereby prevents the liquid fuel from vaporizing insufficiently.

It is possible to appropriately demarcate or form the low thermally-conductive substrate as such a configuration that coincides with the piston head's configuration or the fuel collision zone's configuration. Moreover, the low thermally-conductive substrate can comprise either a sintered body or a cast body. However, the low thermally-conductive substrate comprising a sintered body makes it possible to reduce processing costs by means of net shaping, and to increase or decrease the thermal conductivity by means of controlling the porosity (or density).

Moreover, it is allowable that one of the opposite surfaces of the low thermally-conductive substrate can be provided with a minute irregular surface. Such a minute irregular surface enlarges the low thermally-conductive substrate's superficial area, thereby facilitating the vaporization of liquid fuel that makes contact with the low thermally-conductive substrate. In addition, it is allowable to turn one of the opposite surfaces of the low thermally-conductive substrate that is to be case buried or enveloped into an irregular surface in order to form, besides the minute interstices with sizes that, the coating layer makes, the other second minute interstices that are larger than the first minute interstices with such sizes.

### (B) Coating Treatment (B)-1 Coating Material

A coating material comprises alumina fine particles. The coating material is adhered onto one of the opposite surfaces of the low thermally-conductive substrate to form a coating layer.

Note that the process for producing the alumina fine particles, a major component of the coating material, and the average particle diameter and existence form of the alumina fine particles do not matter at all. However, in order to give the coating layer a desirable form, it is possible to optionally select the raw materials or composition of the coating material and the average particle diameter of the alumina fine particles. For example, it is allowable to choose the alumina fine particles whose average particle diameter is from 5 to 50 μm, preferably from 10 to 40 μm.

As for the coating material, although it is allowable to use an alumina powder that includes only the alumina fine particles genuinely or 100%, it is possible as well to use a mixture powder that includes the other ceramic fine particles, such as silica fine particles, in addition to the alumina fine particles. Moreover, as for the coating material, it is also possible to use an alumina-containing clay that contains alumina. In addition, it is allowable as well to use a mixture of the alumina powder and a clay chat contains alumina. For example, it is preferable to mix an alumina-containing clay with the alumina powder in a proportion of from 0 to 80 by mass with respect to a mass of the alumina powder (i.e., alumina-containing clay/alumina power).

For reference, the alumina-containing clay can be an alumina-silica hydrate, namely, an adulterant of alumina, silica and water, for instance. That is, the alumina-containing clay can comprise Al₂O₃·2SiO₂·2H₂O or Al₂O₃·2SiO₂·4H₂O. Note that, in addition to the aforementioned powders and clays, the coating material can further include, for example, a binder that is required so as to make the alumina fine particles adhere onto the low thermally-conductive substrate.

### (B)-2 Adhering Step

The adhering step is for adhering the coating material onto the low thermally-conductive substrate. Although it does not matter whatever specific method of adhering the coating material is employed, the following are available, for instance: an immersion method of immersing the low thermally-conductive substrate into a coating solution or dispersion liquid in which the coating material is dissolved or dispersed in a solvent or dispersant; and an application method of applying such a coating solution or dispersion liquid onto the low thermally-conductive substrate. Moreover, it is possible to carry out the application method by means of coating the coating solution or dispersion liquid with a brush, or by means of spraying the coating solution or dispersion liquid with a spray gun.

As for the solvent or dispersant that is used for preparing the coating solution or dispersion liquid, it is possible to use organic solvents, such as alcohols, in addition to water. The water is not only inexpensive but also puts load less onto environments. On the other hand, alcohols with low boiling point upgrade the present manufacturing process's productivity, because they dry quickly.

It is allowable to control a mixing proportion of the coating material with the solvent or dispersant in such a range that makes it possible to carry out the adhering step and the subsequent drying step efficiently. For example, it is preferable that the mixing proportion (coating material/solvent or dispersant) can fall in a range of from 1 to 2 by mass, more preferably from 1.2 to 1.8 by mass.

### (B)-3 Drying Step

The drying step is for drying the coating solution or dispersion liquid that is adhered on one of the opposite surfaces of the low thermally-conductive substrate. The drying step helps forming the coating layer, which is made mainly of the alumina fine particles, on one of the opposite surfaces of the low thermally-conductive substrate fully.

It is difficult to specify the temperature and time for drying the coating solution or dispersion liquid in general, because they depend on the composition and adhered amount of the coating solution or dispersion liquid. However, according to the present inventors' investigations or studies, drying the coating solution or dispersion liquid at a high temperature relatively for a short period of time comparatively makes it likely to inhibit drawbacks or inconveniences, such as swellings other than the desirable minute interstices, from occurring in the resulting coating layer.

For example, at the drying step, it is allowable to dry the coating solution or dispersion liquid at about a temperature of from 300 to 600° C. for a time period of from 20 to 60 minutes approximately. Note that a preferable drying temperature can be from 400 to 550° C. Moreover, as for an atmosphere for drying the coating solution or dispersion liquid, it is allowable to dry the low thermally-conductive substrate with the coating solution or dispersion liquid being adhered in an air atmosphere or in an inert atmosphere as far as it provides environment that enables evaporated components of the coating solution or dispersion liquid to be discharged.

### EXAMPLE

Hereinafter, the present invention will be described in more detail with reference to a specific example.

### In-Cylinder Fuel-Injection Type Internal Combustion Engine

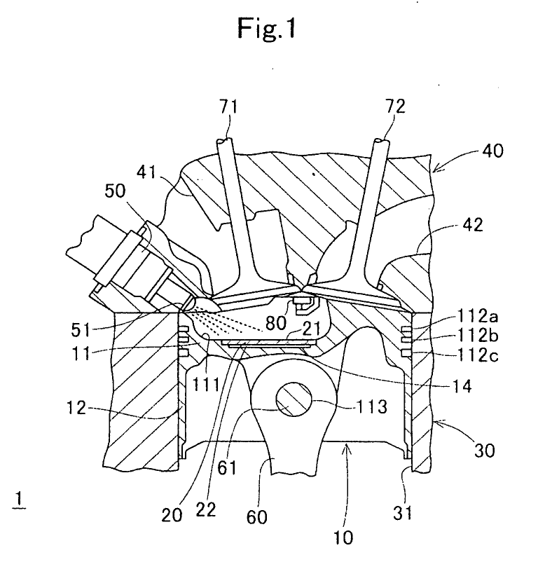

FIG. 1 illustrates an in-cylinder fuel-injection type spark ignition engine 1 (hereinafter simply referred to as “engine 1”), an example that is directed to an in-cylinder fuel-injection type internal combustion engine according to present invention.

The engine 1 comprises a cylinder block 30, a cylinder head 40, and a piston 10. The cylinder head 40 is fixed on the cylinder block 30 by way of a not-shown gasket with not-shown head bolts. The piston 10 is fitted into a cylinder 31 of the cylinder block 30 reciprocably.

The cylinder block 30, the cylinder head 40, and the piston 10 are made of aluminum alloy. For example, the piston 10 is made of AC8A alloy (as per JIS), an aluminum alloy whose thermal conductivity is 134 W/m·K at room temperature and linear-expansion coefficient is 20.9×10⁻⁶/K in a temperature range of from room temperature to 200° C. Moreover, the cylinder 31 of the cylinder block 30 comprises a press-fitted sleeve that is made of cast iron.

The cylinder head 40 is provided with an intake port 41, and a discharge port 42. The opening of the intake port 41 is opened and closed by the cone-shaped head of an intake valve 71 that is driven by a not-shown intake-side cam. The opening of the discharge port 42 is opened and closed by the cone-shaped head of a discharge valve 72 that is driven by a not-shown discharge-side cam. Moreover, the cylinder head 40 is further provided with a spark plug 80 in the middle virtually between the intake valve 71 and the discharge valve 72. In addition, the cylinder head 40 is further provided with an injector 50, a fuel injection valve, on the side of the intake port 41. The injector 50 has an opening 51 through which gasoline (i.e., liquid fuel) being pressurized to predetermined pressure is sprayed into the cylinder 31 of the cylinder block 30.

The piston 10, a piston for in-cylinder fuel-injection type combustion engine according to the present invention, comprises a piston head 11, and a piston body 12. The piston 10 is connected with a connecting rod 60 swingably by way of a piston pin 61. The piston pin 61 is fitted into pin holes 113 that are bored through the piston body 12 of the piston 10. The piston head 11 that is present on the piston 10 is provided with a top ring 112a, a second ring 112b and an oil ring 112c in the outer periphery. Moreover, the piston head 11 is provided with a deep-dish-shaped section 111 on the top surface facing the intake port 41. The gasoline is sprayed from the injector 50 toward the deep-dish-shaped section 111. The inner-wall surfaces of the deep-dish-shaped section 111 (the inside bottom surface, especially) make the “fuel collision zone” that is recited in the present specification.

The deep-dish-shaped section 111 of the piston 10 collects the gasoline, which the injector 50 sprays at around the top dead center at the time of super fuel-lean burning, around a spark plug 80. Thus, even when an air-fuel ratio is high, an air-fuel mixture with ignitable concentration is formed around the spark plug 80. Then, when the spark plug 80 ignites spark discharge between the gaps, the stratified charge combustion occurs within the combustion chamber that is formed between the cylinder head 40 and the piston head 11. On the other hand, at the time of high-load driving, the engine 1 naturally carries out uniformly-mixed combustion in stoichiometric region or fuel-rich region, because the injector 50 sprays the gasoline in the intake process during which the piston 10 descends.

The engine 1 according to an example of the present invention further comprises a low thermal conductor 20. The low thermal conductor 20 is cast buried or enveloped in the deep-dish-shaped section 111 of the piston head 11. Moreover, a superficial portion 21 of the low thermal conductor 20, namely, one of the opposite surfaces thereof, is equivalent to the “low thermally-conductive zone” that is recited in the present specification. As can be seen from FIG. 1, the superficial portion 21 of the low thermal conductor 20 only forms a part of the inner-wall surfaces of the deep-dish-shaped section 111, not the entirety. In other words, the superficial portion 21 appears limitedly in such a section in the piston head 11 that the gasoline, which the injector 50 sprays, can mainly collide with or adhere onto it. Thus, it is possible not only to facilitate the vaporization of the sprayed gasoline, but also to avoid the formation of heat spots that cause knocking.

Moreover, the low thermal conductor 20 comprises a later-described low thermally-conductive substrate, and a coating layer 22 being disposed on the low thermally-conductive substrate's bottom surface. In addition, the coating layer 22 provides a thin minute-intersticed layer 14 between the low thermal conductor 20's lower surface and the piston head 11's top surface. Note that the coating layer 22 and the minute-intersticed layer 14 are not present independently to each other but they exist in interdependent or coexistent relationship or form. A process for manufacturing the piston 10 according to an example of the present invention will be hereinafter described in detail, piston 10 in which the low thermal conductor 20 comprising such a coating layer 22 is cast buried or enveloped in the top.

### (Process for Manufacturing Piston for In-Cylinder Fuel-Injection Type Internal Combustion Engine

### (a) Manufacturing Low Thermally-Conductive Substrate

A low thermally-conductive substrate that made the low thermal conductor 20 comprised a sintered workpiece that was made of Fe—Mn—C system alloy. The sintered workpiece was manufactured as described below.

First of all, a raw-material powder was prepared by mixing a pure Fe powder, a graphite powder and an Fe—Mn alloy powder uniformly with a rotary mixer. Note that the Fe—Mn alloy powder comprised 50%-by-mass Mn, and the balance of Fe and inevitable impurities. The resulting raw-material powder was charged into a cavity of mold (or molding die) that was made of cemented carbide, and was then pressure formed into a powder compact with a forming pressure of 784 MPa using a lubricated-mold warm pressure forming method. Note that the lubricated-mold warm pressure forming method had been developed by some of the present inventors and is disclosed in Japanese Patent Gazette No. 3,309,970.

The resulting powder compact was sintered at 1,250° C. for 30 minutes in a sintering atmosphere that was made up of 1-atm N₂. Thus, a low thermally-conductive substrate comprising a sintered body was manufactured. Note that the sintered body was made up of an Fe—Mn—C alloy whose Mn content was 25% by mass and C content was 1% by mass.

### (b) Coating Treatment

A coating dispersion liquid that had been prepared in advance was coated onto one of the opposite surfaces of the resultant low thermally-conductive substrate. The coating dispersion liquid was comprised ethanol (i.e., a dispersant), and a coating material that was dispersed in the dispersant. The coating material comprised an alumina powder, and alumina-silica hydrate (i.e., an alumina-containing clay). Specifically, the alumina powder exhibited an average particle diameter of 50 μm and an apparent density of from 0.7 to 1.2 g/cm³. Moreover, the used alumina-silica hydrate was “KIBUSHI NENDO” clay. In addition, the alumina powder was compounded with the alumina-silica hydrate in a mixing proportion of 4:1 by mass (i.e., alumina powder:alumina-silica hydrate). Moreover, in the coating dispersion liquid prepared as above, the coating material was compounded with the ethanol in a mixing proportion of 3:2 by mass (i.e., coating material:ethanol).

The thus prepared coating dispersion liquid was coated with a brush onto one of the opposite surfaces of the low thermally-conductive substrate in a thickness of about 0.2 mm (i.e., an applying step). Note that the low thermally-conductive substrate had a diameter of φ39 mm and a thickness of 5 mm and the coating dispersion liquid was coated on the middle of the low thermally-conductive substrate's one of opposite surfaces that extended over the region with a diameter of about φ2.3 mm. The low thermally-conductive substrate that had underwent the applying step was held in an air atmosphere whose temperature was 500° C. for 30 minutes to dry the coating dispersion liquid, thereby forming a coating layer on the one of the opposite surfaces of the low thermally-conductive substrate (i.e., a drying step).

The low thermally-conductive substrate with the coating layer being formed, namely, a low thermal conductor that is directed to the piston according to the present invention, was cast buried or enveloped in a casting by means of gravity casting using a molten metal of aluminum alloy (i.e., a cast burying or enveloping step). Note that the used aluminum alloy was an AC8A alloy in accordance with JIS. Moreover, the molten temperature of the molten metal was controlled at 780° C.

Thus, a test specimen was made, test specimen which comprised the aluminum-alloy cast product and the low thermal conductor being cast buried or enveloped in the cast product. Moreover, as a comparative example, another test specimen was made as well, another rest specimen in which the low thermally-conductive substrate proper that was not subjected to the above-described coating treatment was cast buried or enveloped in the aluminum-alloy casting.

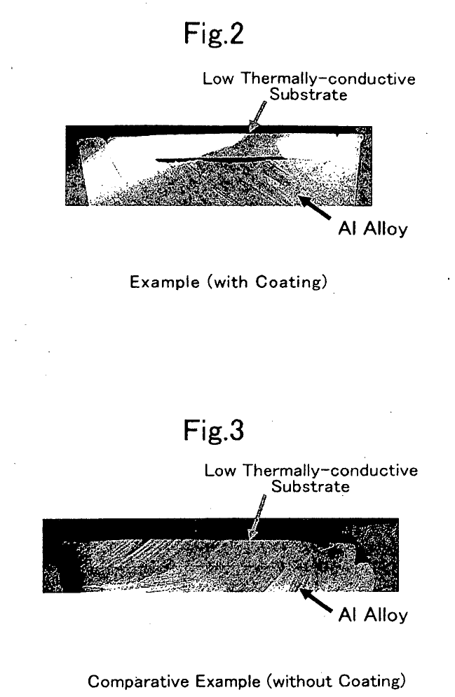

FIGS. 2 and 3 show cross-sectional photographs for displaying the test specimen and comparative test specimen that were cut in the longitudinal direction. As can be seen from FIG. 2, it is ascertained that the test specimen according to an example of the present invention comprised the aluminum-alloy casting, and the low thermal conductor which underwent the coating treatment and was cast buried or enveloped in the aluminum-alloy casting; and that a thin minute-intersticed layer (or coating layer) with a virtually uniform thickness was formed between the low thermally-conductive substrate and the aluminum-alloy casting, namely, the piston body. The minute-intersticed layer was not an assembly of simple hollows, but turned into such a state in which the components of the coating material, that is, the alumina fine particles, remained in or coexisted with the minute interstices or pores. Note that it is believed that to what extent the alumina fine particles are present in the minute-intersticed or coating layer depends on to what extent the coating treatment has been carried out (for example, how thick the coating dispersion liquid has been coated) and how the aluminum-alloy molten metal has been flowed.

Note however that the low thermally-conductive substrate proper cohered to or joined with the aluminum-alloy cast product on the sections of the cast buried or enveloped surface that were free from the minute-intersticed or coating layer.

On the contrary, it is apparent from FIG. 3 that, in the comparative test specimen which comprised the low thermally-conductive substrate proper that had not undergone the above-described coating treatment and was then cast buried or enveloped in the aluminum-alloy cast product, the low thermally-conductive substrate cohered to or joined with the aluminum-alloy cast product over the entire cast-buried or enveloped surface without any minute voids or spaces.

Having now fully described the present invention, it will be apparent to one of ordinary skill in the art that many changes and modifications can be made thereto without departing from the spirit or scope of the present invention as set forth herein including the appended claims.

What is claimed is:

1. A piston for in-cylinder fuel-injection type internal combustion engine, the piston comprising:
a piston body having a top, and being disposed reciprocably within a cylinder in a cylinder block of the internal combustion engine;
a low thermal conductor for forming a low thermally-conductive zone whose thermal conductivity is lower than that of the surroundings, and the low thermal conductor making at least a part of a fuel collision zone with which liquid fuel is coliidable, the liquid fuel being injected from a fuel injection valve into the cylinder, the fuel injection valve being disposed in a cylinder head that is disposed on the cylinder block; and
a piston head in which the low thermal conductor being disposed on the top of the piston body is cast buried;
the piston head comprising an aluminum-alloy casting; and
the low thermal conductor comprising a low thermally-conductive substrate having opposite surfaces, and a coating layer being adhered on at least a part of one of the opposite surfaces of the low thermally-conductive substrate that makes a cast-buried surface to be cast buried in the top of the piston body, and the coating layer comprising alumina (Al₂O₃) fine particles.

2. The piston according to claim 1, wherein the low thermally-conductive substrate comprises: manganese (Mn) in an amount of from 5 to 35% by mass; carbon (C) in an amount of from 0.5 to 1.5% by mass, and the balance of iron (Fe) and inevitable impurities; when the entirety is taken as 100% by mass.

3. The piston according to claim 1, wherein the low thermally-conductive substrate has the cast-buried surface that is formed as an irregular shape partially at least.

4. The piston according to claim 1, wherein the alumina fine particles exhibit an average particle diameter of from 5 to 50 μm.

5. The piston according to claim 1, wherein the coating layer has a thickness of from 0.01 to 0.30 mm.

6. The piston according to claim 1, wherein the alumina fine particles are present in the coating layer in a proportion of from 5 to 100% by volume when the entire coating layer is taken as 100% by volume.

7. The piston according to claim 1, wherein the low thermally-conductive substrate comprises a Ti alloy or a stainless alloy.

8. An in-cylinder fuel-injection type internal combustion engine comprising:
a cylinder block having a cylinder;
a cylinder head being disposed on the cylinder block;
a fuel injection valve being disposed in the cylinder head; and
a piston for in-cylinder fuel-injection type internal combustion engine, the piston being as set forth in claim 1.

9. The in-cylinder fuel-injection type internal combustion engine according to claim 8 making a gasoline engine.

10. The in-cylinder fuel-injection type internal combustion engine according to claim 8 making a diesel engine.

11. A process for manufacturing piston for in-cylinder fuel-injection type internal combustion engine,
the piston comprising: a piston body having a top, and being disposed reciprocably within a cylinder in a cylinder block of the internal combustion engine; a low thermal conductor for forming a low thermally-conductive zone whose thermal conductivity is lower than that of the surroundings, and the low thermal conductor making at least a part of a fuel collision zone with which liquid fuel is coliidable, the liquid fuel being injected from a fuel, injection valve into the cylinder, the fuel injection valve being disposed in a cylinder head that is disposed on the cylinder block; and a piston head in which the low thermal conductor being disposed on the top of the piston body is cast buried;
the manufacturing process comprising the steps of:
adhering a coating material, comprising alumina fine particles onto at least a part of one of opposite surfaces of a low thermally-conductive substrate, thereby forming a coating layer on one of the opposite, surfaces; and
casting the piston head while contacting the one of the opposite surfaces of the low thermally-conductive substrate that is provided with the coating layer with a molten metal of aluminum alloy, thereby making an aluminum-alloy piston head in which the low thermal conductor is cast buried.

12. The manufacturing process according to claim 11, wherein the adhering step comprises a step of immersing at least a part of one of the opposite surfaces of the low thermally-conductive substrate into a dispersion liquid in which the coating material is dispersed in a dispersant.

13. The manufacturing process according to claim 11, wherein the adhering step comprises a step of applying a dispersion liquid in which the coating material is dispersed in a dispersant onto at least a part of one of the opposite surfaces of the low thermally-conductive substrate.

14. The manufacturing process according to claim 12, wherein the adhering step further comprises a step of drying the low thermally-conductive substrate which has been immersed into the dispersion liquid.

15. The manufacturing process according to claim 13, wherein the adhering step further comprises a step of drying the low thermally-conductive substrate on which the dispersion liquid has been applied.

16. The manufacturing process according to claim 12, wherein the dispersant comprises water or alcohol.

17. The manufacturing process according to claim 13, wherein the dispersant comprises water or alcohol.

18. The manufacturing process according to claim 12, wherein dispersion liquid comprises the coating material in a mixing proportion of from 1 to 2 by mass with respect to a mass of the dispersant.

19. The manufacturing process according to claim 13, wherein dispersion liquid comprises the coating material in a mixing proportion of from 1 to 2 by mass with respect to a mass of the dispersant.

20. The manufacturing process according to claim 11, wherein the coating material comprises at least one member that is selected from the group consisting of alumina powders and alumina-containing clays.

21. The manufacturing process according to claim 20, wherein the coating material comprises a mixture of an alumina powder and an alumina-containing clay.

22. The manufacturing process according to claim 20, wherein the alumina-containing clay is mixed with the alumina powder in a mixing proportion of from 0 to 80 by mass with respect to a mass of the alumina powder.

23. The manufacturing process according to claim 20, wherein the alumina-containing clays comprise an alumina-silica hydrate.

24. The manufacturing process according to claim 14, wherein the low thermally-conductive substrate is dried at a temperature of 50° C. or more in the drying step.

25. The manufacturing process according to claim 15, wherein the low thermally-conductive substrate is dried at a temperature of 50° C. or more in the drying step.
